(19) United States
(12) Patent Application Publication
(10) Pub. No.: US 2011/0119621 A1
(43) Pub. Date: May 19, 2011

(54) PROVIDING CONTENTS INFORMATION FOR NETWORK TELEVISION

(75) Inventors: Suyeon Cho, Pyeongtaek-si (KR); Daesuk Park, Pyeongtaek-si (KR); Jaekyung Lee, Pyeongtaek-si (KR); Jungwon Cho, Pyeongtaek-si (KR); Wonchul Bae, Pyeongtaek-si (KR)

(73) Assignee: LG ELECTRONICS INC., Seoul (KR)

(21) Appl. No.: 12/817,010

(22) Filed: Jun. 16, 2010

(30) Foreign Application Priority Data
Nov. 16, 2009 (KR) 10-2009-0110151
Nov. 17, 2009 (KR) 10-2009-0111047

(51) Int. Cl. G06F 3/048

(52) U.S. Cl. 715/788; 715/838

(57) ABSTRACT

A contents processing device connectable to a network includes a network interface unit configured to request, via the network, contents information from each of a plurality of contents providers, and to receive, via the network, contents information from each of the plurality of contents providers; a user interface unit configured to receive a user input; and a control unit configured to control, based on the user input, displaying of multiple contents windows, and the received contents information corresponding respectively to the plurality of content providers respectively in the multiple contents windows.

### CROSS-REFERENCE TO RELATED APPLICATIONS

This application claims priority under 35 U.S.C. §119 and 35 U.S.C. §365 to Korean Patent Application Nos. 10-2009-0110151 filed on Nov. 16, 2009, and 10-2009-0111047 filed on Nov. 17, 2009, each of which are hereby incorporated by reference in its entirety.

### BACKGROUND

1. Field of the Invention

The present invention relates to a display device that is equipped with a network module to receive contents by connecting to a plurality of contents provider servers through a network. More particularly, the present invention relates to a display device equipped with a network module, and provides a method for receiving/displaying contents information from a plurality of contents providers by only one input without inputting, by a user, a command for connecting to the contents providers. When the display device is equipped with a broadcast signal processing module, it can play back both broadcast signals and contents received through the network.

2. Discussion of the Related Art

With the development and commercialization of digital TV technology in the conventional analog broadcast, the internet (as well as the conventional transmission media) connected to each home can be used to provide various content services such as real-time broadcasts, COD (Contents On Demand), games and news to users.

An IPTV (Internet Protocol TV) is an example of the content service based on the Internet. The IPTV transmits various information, video contents and broadcasts through the high-speed Internet to provide the same to the televisions of users.

Recently, a broadband TV or a Web TV has been proposed as a kind of network TV that has evolved from the IPTV. Unlike the IPTV, the broadband TV or the Web TV are provided with a choice of a plurality of contents providers so that users can connect to the plurality of contents providers to receive various VODs, games and videophone services provided by the plurality of contents providers.

However, on a network with a plurality of contents providers, users must connect separately to the contents providers in order to search for their desired contents and must input separate commands at that time. Also, because contents information varies according to the contents providers, the users are inconvenienced in selecting the contents.

### SUMMARY OF THE INVENTION

Embodiments of the invention provide a method for enabling a user to conveniently acquire information about contents provided by a plurality of contents providers on a network.

Embodiments of the invention also provide a method for providing information about various contents through one screen to a user, which are provided by a plurality of contents providers on a network.

Embodiments of the invention also provide a user interface for enabling a user to perform various operations for each of the contents or the contents providers and various settings through a contents information display screen.

In one embodiment of the invention, a contents processing device connectable to a network includes a network interface unit configured to request, via the network, contents information from each of a plurality of contents providers, and to receive, via the network, contents information from each of the plurality of contents providers; a user interface unit configured to receive a user input; and a control unit configured to control, based on the user input, displaying of multiple contents windows, and the received contents information corresponding respectively to the plurality of content providers respectively in the multiple contents windows.

In another embodiment of the invention, a method of providing contents information for a contents processing device connectable to a network including requesting, via the network, contents information from each of a plurality of contents providers; receiving, via the network, contents information from each of the plurality of contents providers; and displaying on a display unit, based on user input, multiple contents windows, and the received contents information corresponding respectively to the plurality of content providers respectively in the multiple contents windows.

In another embodiment of the invention, a method of providing contents information for a contents processing device connectable to a network includes, requesting, via the network, contents information from each of a plurality of contents providers; receiving, via the network, contents information from each of the plurality of contents providers; displaying on a display unit, based on user input, multiple contents windows, and the received contents information corresponding respectively to the plurality of content providers respectively in the multiple contents windows; and editing a configuration of the multiple contents windows.

The details of one or more embodiments of the invention are set forth in the accompanying drawings and the description below. Other features will be apparent from the description and drawings, and from the claims.

### BRIEF DESCRIPTION OF THE DRAWINGS

FIG. 1 illustrates a network configuration of a network TV system according to an embodiment of the invention.

FIG. 2 is a block diagram illustrating a configuration of a network TV according to an embodiment of the invention.

FIG. 3 is a block diagram illustrating a configuration of a network TV capable of implementing a 3D image according to an embodiment of the invention.

FIGS. 4 and 5 illustrate an example of a remote controller for controlling the network TV of FIG. 2 or 3.

FIG. 6 is a block diagram illustrating an interface unit of a network TV of the network TV system of FIG. 1 and a motion-sensitive remote controller of FIG. 4.

FIG. 7 illustrates a menu screen of a network TV according to an embodiment of the invention.

FIG. 8 illustrates an example of an initial screen provided when a user connects to a contents provider server.

FIG. 9 illustrates a network configuration for performing a contents information providing method according to an embodiment of the invention.

FIGS. 10 and 11 illustrate menus provided to a user to request contents information according to an embodiment of the invention.

FIGS. 12 to 16 illustrate views of contents browsing screens according to embodiments of the invention.

FIG. 17 illustrates a view of a content browsing screen for explaining a method for providing contents of each contents provider according to an embodiment of the invention.

FIG. 18 is a flow chart illustrating a contents browsing operation according to an embodiment of the invention.

FIGS. 19 and 20 illustrate views of contents browsing screens for explaining a method for setting an option for a contents provider according to an embodiment of the invention.

FIG. 21 illustrates a contents browsing menu using a favorite CP group according to an embodiment of the invention.

FIG. 22 is a flow chart illustrating a method for setting an option for a contents provider using a contents browsing screen according to an embodiment of the invention.

FIGS. 23 to 27 illustrate views of contents browsing screens for explaining methods for editing the contents browsing screens according to embodiments of the invention.

FIG. 28 is a flow chart illustrating a method for editing a contents browsing screen according to an embodiment of the invention.

FIGS. 29 and 30 illustrate a view of a content browsing screen for explaining a method for setting an option for each of the contents according to an embodiment of the invention.

FIG. 31 is a flow chart illustrating a method for setting an option for contents using a contents browsing screen according to an embodiment of the invention.

### DETAILED DESCRIPTION OF THE EMBODIMENTS

Reference will now be made in detail to the embodiments of the present invention, examples of which are illustrated in the accompanying drawings.

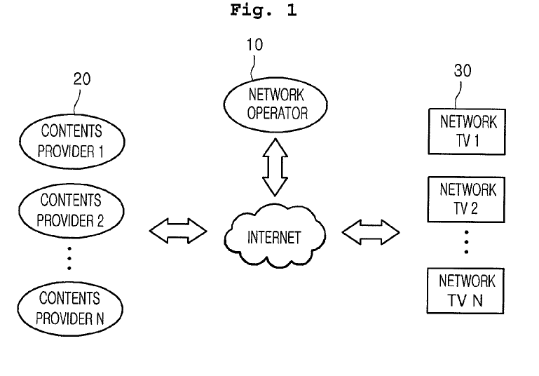

FIG. 1 illustrates a network configuration of a network TV system according to an embodiment of the invention.

Referring to FIG. 1, a network TV system according to an embodiment of the invention may include a network operator 10, at least one contents provider (CP) 20, and at least one network TV 30, which may be connected to each other through a network such as the Internet.

The network operator 10 provides the network TV 30 with base software that is necessary to normally operate or provide the contents of the contents provider 20 in the network TV 30, or software that is necessary to operate the network TV 30. Also, the network operator 10 provides the contents provider 20 with the hardware information of the network TV 30 that is necessary to normally execute or provide contents in the network TV 30.

For example, the network operator 10 provides a basic screen frame that is necessary to provide the contents from contents providers to the network TV 30, and a user interface that is used by the user to select contents, to input various commands, or to display the corresponding output. Also, the network operator 10 may provide data for updating the firmware or software of the network TV 30. The network operator 10 may be identical to the manufacturer of the network TV 30.

The contents provider 20 generates various contents on the network, formats the same to be reproducible in the network TV 30, and provides the contents at the request of the network TV 30. The contents according to an embodiment of the invention may be certain multimedia contents that can be provided through the network.

According to an embodiment of the invention, the contents provider 20 may provide contents to the network TV 30 directly through the Internet or indirectly through the network operator 10.

The network TV 30 may be equipped with dedicated firmware that is used to perform contents playback, contents search, and contents list display separately for each contents provider 20. The firmware may be installed in the network TV 30 during the manufacture of the network TV 30, or may be downloaded from the contents provider 20 or the network operator 10 during the use by the user.

The firmware of the network TV 30 may be considered as a program for playback or execution of the contents provided by the contents provider 20. The firmware may vary according to the type of contents provided by the contents provider 20. For example, if the contents provider 20 is a VOD service provider, the firmware may be a VOD playback program. If the contents provider 20 is an AOD/MOD service provider, the firmware may be an AOD/MOD playback program. If the contents provider 20 is a videophone service provider, the firmware may be a videophone program.

The network TV 30 receives contents from the contents provider 20 to execute or play back the same. According to an embodiment of the invention, the network TV 30 includes a TV (e.g., digital TV) equipped with a network module and a display device equipped with a network module such as a network phone or a broadcast receiver such as a settop box or can be a computer, multimedia device, mobile terminal, etc. Embodiments of the invention may be applicable to any network-connectable device which need not include a display, and implementation of the inventive concept is not limited. Embodiments of the invention may also be referred to as a contents processing device

More specifically, the contents provider 20 may be a service provider that creates or distributes various contents to be provided to the network TV 30. Examples of the contents provider 20 include a TV broadcasting station, a radio broadcasting station, a VOD service provider, an AOD service provider, a game service provider, a videophone service provide, a weather information provider, a picture-related service provider, and a user created content (UCC) provider.

The TV broadcasting station may be a terrestrial broadcasting station or a cable broadcasting station that creates a program viewable by users and converts the same in a digital format prior to its transmission.

The radio broadcasting station provides audio contents with or without video contents.

The VOD service provider and the AOD service provider have different characteristics from the radio broadcasting station. That is, the VOD or the AOD provides a service that allows the user to store desired broadcast programs, movies, or music, and enjoy the same by playback at desired times. For example, if a user fails to complete a viewing of a desired broadcast program due to a lack of time, the user can complete the viewing of the desired broadcast program at desired times by direct playback or by downloading the corresponding file by a connection to a site providing the broadcast program such as the VOD or the AOD service provider.

The AOD service provider provides a streaming service for audio contents.

The MOD (Music On Demand) service provider enables the user to download and enjoy a desired music.

The videophone service provider provides a relay service that enables the user to enjoy a videophone call with a user of another network TV through the network. The weather information provider provides weather information of various regions. The picture-related service provider provides a tool for editing and storing pictures.

Besides, the contents provider 20 may be any server operator (e.g., such as a PF (Packet Filter) server operator, an EPG service provider, an ECG (Electronic Content Guide) service provider or a portal server operator) that can provide various services to network TVs through the Internet.

The PF server service is provided by an enterprise that manages all broadcast information and location information, provided by a contents provider, on behalf of the contents provider. The PF server contains broadcast time information of the corresponding broadcasting station, location information for broadcasting, and user-accessible information.

The EPG service provides EPG information that enables the user to check broadcast programs for each time zone and detect the same on a channel-by-channel basis.

The ECG service provides the user with the contents information of contents provider and information about the access authority and the location of an access server. For example, the ECG service includes a contents server access function and an electronic program guide that displays contents information in detail.

The portal server service is a web service provided by each broadcasting station. When receiving a request from a user terminal, a portal server connects to a web server of a broadcasting station or an enterprise that services contents. The portal server service enables to search a program list that is provided by each broadcasting station or contents service providers.

The network TV 30 includes a network interface connectable to the network. The network TV 30 is allocated within an IP address to receive a data packet through the network. If the data packet is multimedia data (such as video and audio), the network TV 30 may store or play back the data packet.

The network TV 30 may be configured to bidirectionally transmit user requirements while processing the multimedia data. Also, a remote controller or a user input unit (such as control buttons) for control of the network TV 30 may be provided with buttons for control of the network TV, and buttons for selection of various menus and control thereof.

The configuration and operation of the network TV 30 will be described below in detail.

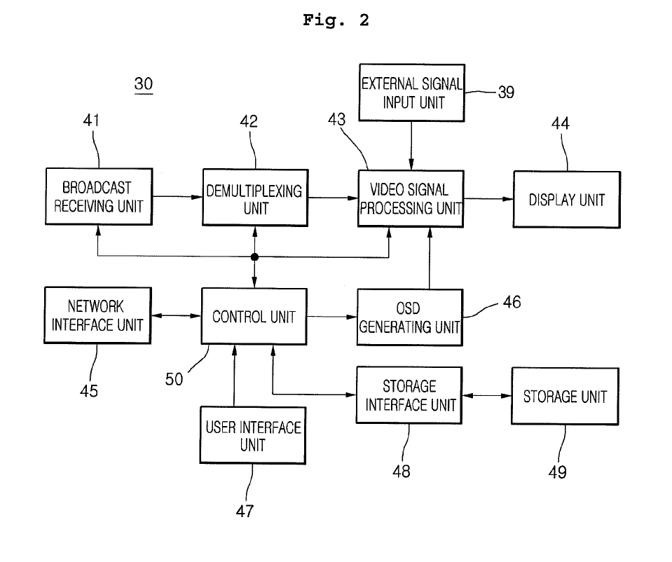

FIG. 2 is a block diagram illustrating a configuration of the network TV 30 according to an embodiment of the invention.

In addition to a function of receiving contents through the network, the network TV 30 may include a function of receiving RF broadcast signals by radio or by cable through a broadcast receiving unit 41.

As illustrated in FIG. 2, the network TV 30 according to an embodiment of the invention includes a broadcast receiving unit 41, a demultiplexing unit 42, a video signal processing unit 43, a display unit 44, a network interface unit 45, an OSD generating unit 46, a user interface unit 47, a storage interface unit 48, a storage device 49, an external signal input unit 39, and a control unit 50. All the components of the network TV 30 are operatively coupled and configured.

Among the above components, the broadcast receiving unit 41, the demultiplexing unit 42 and the video signal processing unit 43 may constitute a broadcast processing unit that receives a broadcast signal and processes the same into a format for output to the display unit 44.

If contents are digital broadcasts, a digital broadcast signal may be transmitted in a transport stream format that is packetized by time-division multiplexing a video signal, an audio signal and additional data.

The broadcast receiving unit 41 may include an antenna for receiving an external broadcast signal. Also, the broadcast receiving unit 41 may include a tuner for tuning a broadcast signal with a corresponding frequency band according to a tuning control signal of the control unit 50, and a demodulator (a demodulating unit) for outputting a tuned broadcast signal of a specific channel into a transport stream format through VSB (Vestigial Sideband) demodulation and error correction.

The broadcast signal received through the broadcast receiving unit 41 is demultiplexed by the demultiplexing unit 42 into a video signal, an audio signal and various additional data such as PSIP (Program and System Information Protocol) data to be outputted in a bitstream format.

The video data demultiplexed by the demultiplexing unit 42 are processed by the video signal processing unit 43 to be displayed on the display unit 44.

The video signal processing unit 43 includes an MPEG-2 decoder and a scaler that converts the video data into a format that is in accordance with the aspect ratio, the resolution and the vertical frequency according to the display standards of the display unit 44.

Herein, various displays such as DLP (Digital Light Processing) displays, LCDs (Liquid Crystal Displays) and PDPs (Plasma Display Panels) may be used as the display unit 44.

The audio signal is processed by an audio processing unit (not illustrated) to be outputted through a speaker, wherein the audio signal processing unit may include an AC-3 decoder.

The additional data demultiplexed by the demultiplexing unit 42 may be stored in the storage unit 49 through the storage interface unit 48.

The storage unit 49 may be implemented using EEPROMs (electrically erasable programmable read-only memories).

The user interface unit 47 is configured to receive a request command from the user. The user interface unit 47 may include an infrared (IR) receiving unit for receiving an infrared signal inputted through a remote controller, and a key input unit provided at one side of the panel.

The network interface unit 45 receives contents or data through the network from the contents provider 20 or the network operator 10. That is, the network interface unit 45 receives contents (e.g., broadcast, game, VOD, and broadcast signals) and related information that are provided from the contents provider through the network. Also, the network interface unit 45 receives update files and update information of the firmware.

The OSD generating unit 46 generates a menu screen for inputting a determination signal of the user, in an OSD (On Screen Display) mode.

That is, the OSD generating unit 46 may display information related to contents, which are received through the network interface unit 45, through the display unit 44.

The external signal input unit 39 is an interface that can receive an input signal from other playback devices such as DVD players and game devices. Another playback device may be connected to the external signal input unit 39 to display the multimedia data of the playback device on the display unit 44.

The control unit 50 controls an overall operation according to a command input from the user interface unit 47. The control unit 50 receives and executes an update file of the firmware that is the software of the contents provider 20 received from the network operator 10.

According to an embodiment of the invention, the network TV 30 may display a 3D image. A menu screen of the network TV 30 may be provided in a 3D mode. Also, the network TV 30 may receive and display 3D contents that are provided by the contents provider 20.

An additional component is necessary to output the 3D image.

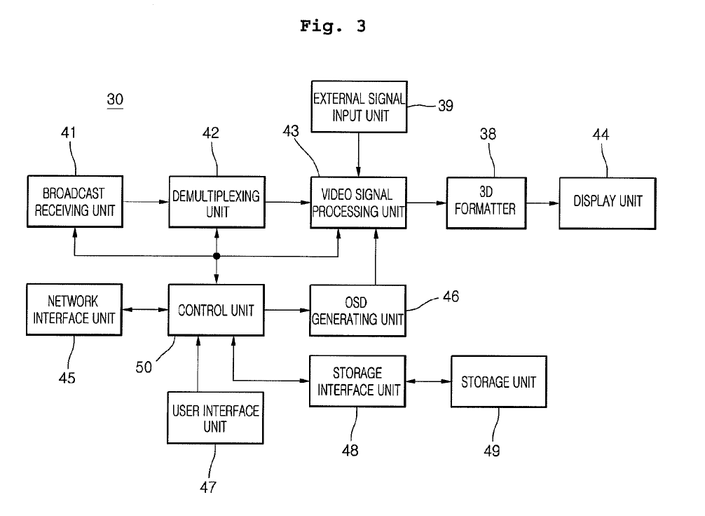

FIG. 3 illustrates a configuration of a network TV capable of processing a 3D image according to an embodiment of the invention. The components other than the 3D formatter 38 may be identical to those of FIG. 2. All the components of the network TV 30 are operatively coupled and configured.

Referring to FIG. 3, a 3D formatter 38 is disposed at an output terminal of the video signal processing unit 43. The 3D formatter 38 converts an image, processed by the video signal processing unit 43, into a 3D image and transfers the 3D image to the display unit 44. According to an embodiment of the invention, the OSD generating unit 46 may include an additional 3D formatter that converts an OSD output into a 3D format.

The configuration of FIG. 3 is merely an exemplary embodiment of the invention, and various well-known techniques may be used to process a 3D image.

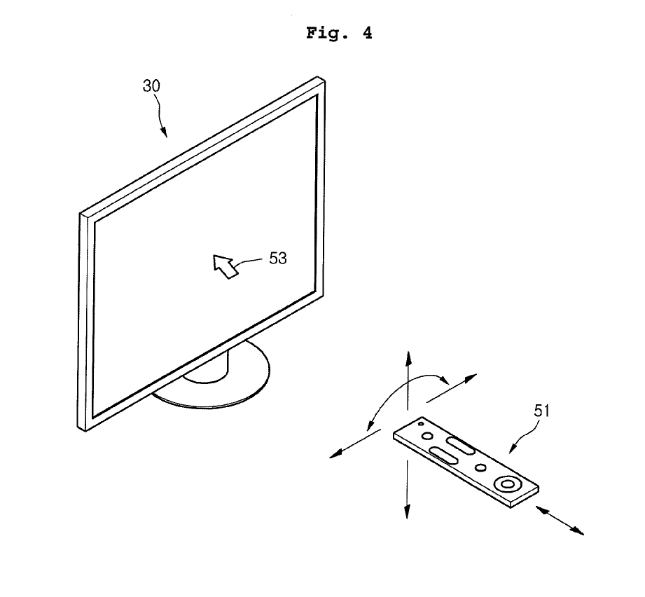

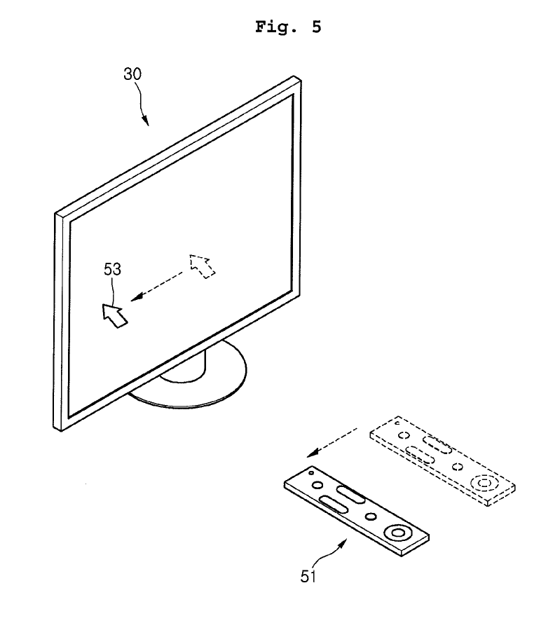

FIGS. 4 and 5 illustrate an example of a remote controller for controlling the network TV 30 of FIG. 2 or 3.

A remote controller may transfer a control signal to the control unit 50 through a wireless signal (e.g., RF signals and infrared signals) receiver that may be included in the user interface unit 47. The remote controller described with reference to FIGS. 4 to 6 is a remote controller that is sensitive to both a button input of a user and a gesture of a user, and will be referred to as a motion-sensitive remote controller 51.

In this embodiment of the invention, the motion-sensitive remote controller 51 may communicate by signals with the network TV 30 according to the IR and RF communication standards. As illustrated in FIG. 4, a pointer (or a cursor) 53 may be displayed on the network TV 30 at a point that is pointed to by the motion-sensitive remote controller 51.

The user may move the motion-sensitive remote controller 51 up and down, left and right, or back and forth, or may rotate it. The pointer 53 displayed on the network TV 30 may move in a way that corresponds to a movement of the motion-sensitive remote controller 51. FIG. 5 illustrates that the pointer 53 displayed on the network TV 30 moves according to the movement of the motion-sensitive remote controller 51.

As illustrated in FIG. 4, if the user moves the motion-sensitive remote controller 51 to the left, the pointer 53 displayed on the network TV 30 moves to the left accordingly. In this embodiment of the invention, the motion-sensitive remote controller 51 may include a sensor for determining the movement of the motion-sensitive remote controller 51. Information about the movement of the motion-sensitive remote controller 51 that is sensed by the sensor of the motion-sensitive remote controller 51 is transmitted to the network TV 30. The network TV 30 determines the movement of the motion-sensitive remote controller from the information about the movement of the motion-sensitive remote controller 51, and calculates a corresponding coordinate value of the pointer 53.

An acceleration sensor, a gyro sensor or a geomagnetic sensor may be used as a sensor for determining the movement of the motion-sensitive remote controller 51.

FIGS. 4 and 5 illustrate an example where the pointer 53 that is displayed on the display unit 44 moves according to the up/down/left/right movement and/or the rotation of the motion-sensitive remote controller 51. The moving speed or the moving direction of the pointer 53 may correspond to that of the motion-sensitive remote controller 51.

In this embodiment of the invention, the pointer 53 that is displayed on the network TV 30 is configured to move according to the movement of the motion-sensitive remote controller 51. As another example, a predetermined command may be input into the network TV 30 according to the movement of the motion-sensitive remote controller 51. That is, if the motion-sensitive remote controller 51 moves back and forth, the size of an image displayed on the network TV 30 may be increased or reduced, or vice versa.

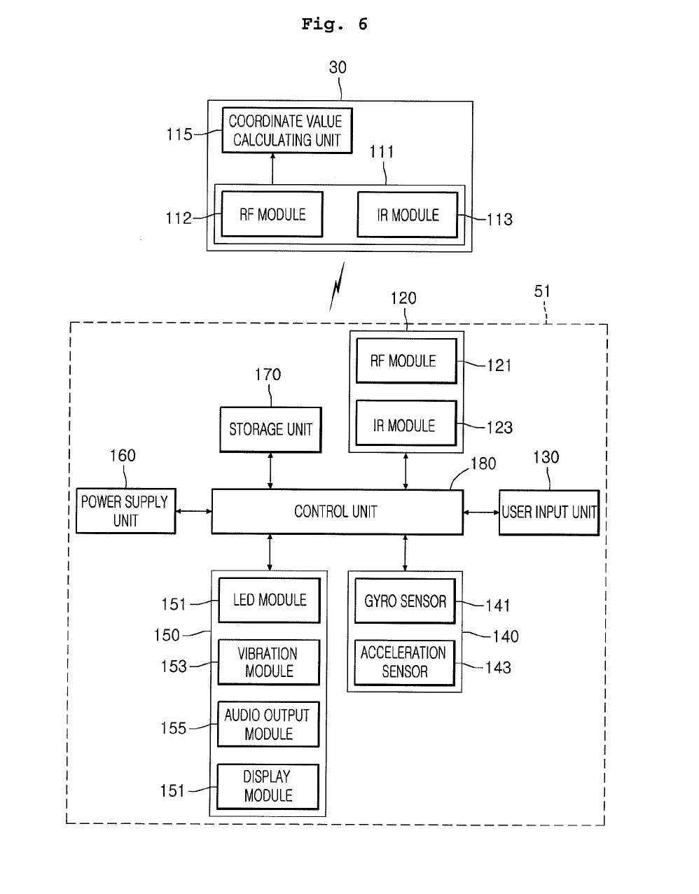

FIG. 6 is a block diagram illustrating the interface unit 47 of the network TV 30 of the network TV system of FIG. 1 and the motion-sensitive remote controller 51 of FIG. 4.

Referring to FIG. 6, the network TV 30 may include a coordinate value calculating unit 115 and a wireless communication unit 111. The coordinate value calculating unit 115 may be included in the control unit 50. The wireless communication unit 111 may be included in the user interface unit 47. The wireless communication unit 111 may include an RF module 112 or an IR module 113. All the components of the network TV 30 are operatively coupled and configured.

The motion-sensitive remote controller 51 may include a wireless communication unit 120, a user input unit 130, a sensor unit 140, an output unit 150, a power supply unit 160, a storage unit 170, and a control unit 180. All the components of the motion-sensitive remote controller 51 are operatively coupled and configured.

The wireless communication unit 111 communicates by signals with the network TV 30. In this embodiment of the invention, the motion-sensitive remote controller 51 may include an RF module 121 for communicating by RF signals with the user interface unit 47 of the network TV 30 according to the RF communication standards. Also, the motion-sensitive remote controller 51 may include an IR module 123 for communicating by IR signals with the user interface unit 47 of the network TV 30 according to the IR communication standards.

In this embodiment of the invention, the motion-sensitive remote controller 51 transmits signals, which contains information about the movement of the motion-sensitive remote controller 51, to the network TV 30 through the RF module 121. Also, the motion-sensitive remote controller 51 may receive signals from the network TV 30 through the RF module 112. Also, the motion-sensitive remote controller 51 may transmit commands about power on/off, channel change, volume change to the network TV 30 through the IR module 123, if necessary.

The user input unit 130 may include a keypad or buttons. The user may control the user input unit 130 to input commands related to the network TV 30 into the motion-sensitive remote controller 51. If the user input unit 130 includes a hard key button, the user may input commands related to the network TV 30 into the motion-sensitive remote controller 51 through a push operation of the hard key button. If the user input unit 130 includes a touch screen, the user may input commands related to the network TV 30 into the motion-sensitive remote controller 51 by touching a soft key of the touch screen. Also, the user input unit 130 may include various kinds of input units (e.g., a scroll key and/or a jog key) that can be controlled by the user, and to which the present invention is not limited.

The sensor unit 140 may include a gyro sensor 141 or an acceleration sensor 143. The gyro sensor 141 may sense information related to the movement of the motion-sensitive remote controller 51. For example, the gyro sensor 141 may sense information related to the movement of the motion-sensitive remote controller 51, with reference to x, y, and z axes, and/or rotations. The acceleration sensor 143 may sense information related to the moving speed of the motion-sensitive remote controller 51. The output unit 150 may output video or audio signals that correspond to the control of the user input unit 130 or the signals received from the network TV 30. By using the output unit 150, the user may detect whether there is control of the user input unit 130 or whether there is control of the network TV 30.

As an example, the output unit 150 may include a light emitting diode (LED) module 151 for outputting light, an audio output module 155 for outputting an audio, and a display module 157 for displaying a video, when the user input unit 130 is controlled or a signal of the network TV 30 is communicated through the wireless communication unit 120, a vibration module 153 for generating a vibration.

The power supply unit 160 may supply power to the motion-sensitive remote controller 51. The power supply unit 160 can reduce power consumption by interrupting the supply of power when the motion-sensitive remote controller 51 does not move for a predetermined time. The power supply unit 160 may resume the supply of power when a predetermined key of the motion-sensitive remote controller 51 is touched or controlled, for example.

The storage unit 170 may store various kinds of application data that are necessary to control or operate the motion-sensitive remote controller 51. If the motion-sensitive remote controller 51 wirelessly communicates by signals with the network TV 30 through and the RF module 121, the motion-sensitive remote controller 51 and the network TV 30 may communicate by signals through a predetermined frequency band. The control unit 180 of the motion-sensitive remote controller 51 may store information about a frequency band for wirelessly communicating by signals with the network TV 30 paired with the motion-sensitive remote controller 51, in the storage unit 170 for reference.

The control unit 180 controls an overall operation related to the control of the motion-sensitive remote controller 51. The control unit 180 may transmit a signal corresponding to a predetermined key control of the user input unit 130 or a signal corresponding to an operation of the motion-sensitive remote controller 51, which is sensed by the sensor unit 140, to the wireless communication unit 111 of the network TV 30 through the wireless communication unit 120.

As described above, the network TV 30 may include the wireless communication unit 111 for wirelessly communicating by signals with the motion-sensitive remote controller 51, and the coordinate value calculating unit 115 for calculating the coordinate value of a pointer corresponding to the movement of the motion-sensitive remote controller 51.

The wireless communication unit 111 may communicate by signals with the motion-sensitive remote controller 51 wirelessly through the RF module 112. Also, wireless communication unit ill may receive a signal that is transmitted from the motion- sensitive remote controller 51 through the IR module 113 according to the IR communication standards.

The coordinate value calculating unit 115 may correct hand shakes or errors from signals corresponding to the movements of the motion-sensitive remote controller 51, which are received through the radio communication unit 111, to calculate a coordinate value (x, y) of the pointer 53 to be displayed on the display unit 44.

Also, a transmission signal of the motion-sensitive remote controller 51, which is inputted into the network TV 30 through the user interface unit 47, is transmitted to the control unit 50 of the network TV 30. The control unit 50 determines information about the movement of the motion-sensitive remote controller 51 and key control information from the signals received from the motion-sensitive remote controller 51 and controls the network TV 30 accordingly.

A menu screen of the network TV 30 according to an embodiment of the invention and a control method thereof will be described below.

A menu screen of the network TV 30 according to an embodiment of the invention is an initial screen or a main screen when the network TV 30 enters an operation mode (hereinafter referred to as a NetCast mode) that provides a menu for connecting to one of the contents providers (CPs). The menu screen may include a plurality of icons 212 representing a plurality of contents providers. According to an embodiment of the invention, the menu screen may further include a background image 201.

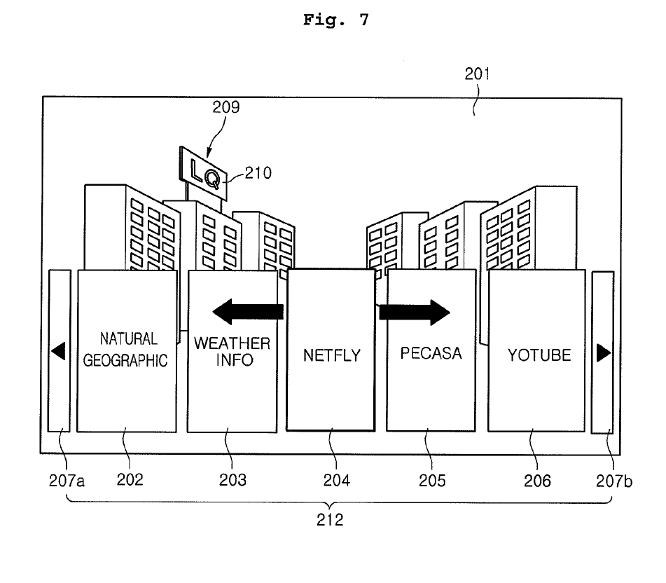

FIG. 7 illustrates a menu screen of the network TV 30 according to an embodiment of the invention.

An image with a theme of ‘city’ is used as the background image 201 in the background of the menu screen, and the icons 212 representing the contents providers are displayed in the foreground of the menu screen. The background image 201 of the menu screen may have a specific theme. In addition to the ‘city’ theme illustrated in FIG. 7, the background image may have various themes such as jungle, department store, seashore, space, and an animation scene. The background image 201 may include graphic objects for selectively inserting a basic image suitable for the theme and other images.

The icons 212 are buttons for connecting to contents servers. The user may select one of the icons 212 to access a server of the selected contents provider to receive a desired service. The icon 212 may also be related to the background image 201. That is, the icon 212 may include an object suitable for the theme of the background image 212. For example, as illustrated in FIG. 7, the icons 212 may be displayed in the form of a billboard or a structure that is erected on a city street. The image displayed on the icon 212 may be provided by each contents provider.

The icons 212 or an image on the icon 212 may also change when the background image 201 is changed according to user information such as a region or a geographic location.

The user may use the motion-sensitive remote controller 51 of FIGS. 4 to 6 to select the icons 212. Other ways of selecting the icons 212 is possible such as by use of buttons of the network TV 30.

As an embodiment of contents providers, FIG. 7 illustrates icons of contents providers such as NATURAL GEOGRAPHIC 202, WEATHER INFO 203, NETFLY 204, PECASA 205, and YOTUBE 206.

For example, the NATURAL GEOGRAPHIC 202 is a contents provider that provides contents related to natural sciences. Also, the WEATHER INFO 203 is a contents provider that provides weather information. Also, the NETFLY 204 is a contents provider that provides movie-related information. Also, the PECASA 205 is a contents provider that provides picture-related contents. Also, the YOTUBE 206 is a contents provider that provides contents related to VOD (Video On Demand).

According to an embodiment of the invention, various types of additional icons may be further displayed on the menu screen. Scroll bars 207a and 707b are disposed at the left and right of the icons 212, so that the user may select the scroll bars 207a and 207b to display the additional icons.

The user may select one of the icons 212 to access a server of one of the contents providers and view or use contents thereof. The format of the menu screen and the size, location, arrangement and number of icons displayed on the menu screen may vary according to embodiments of the invention.

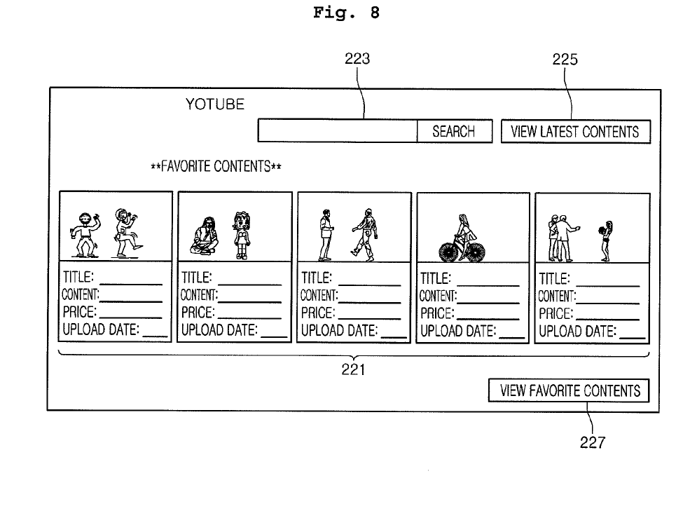

FIG. 8 illustrates an example of an initial screen provided when the user connects to a contents provider server.

FIG. 8 illustrates an initial screen of a content provider “YOTUBE”, which includes, for example, icons 221 for representing favorite contents, a search window 223 for inputting search keywords, a menu 225 for representing latest contents, and a menu 227 for representing more favorite contents.

The initial screen varies according to contents providers and would continue to change. In general, favorite contents, latest contents and a search window are provided on the initial screen of a content providers as illustrated in FIG. 8.

When a list of favorite contents or latest contents is displayed, the list may be configured to include the titles of the contents. In general, each of the contents is represented by one icon 221 as illustrated in FIG. 8. Also, the icon 221 includes a thumbnail image of the contents and detailed information of the contents such as title, content, price, and upload date.

However, according to the related art, users must access a plurality of contents provider servers in order to view favorite contents and latest contents or perform a search operation. According to embodiments of the invention, contents information is received by accessing a plurality of contents provider servers, and the contents information of contents providers are displayed on one screen.

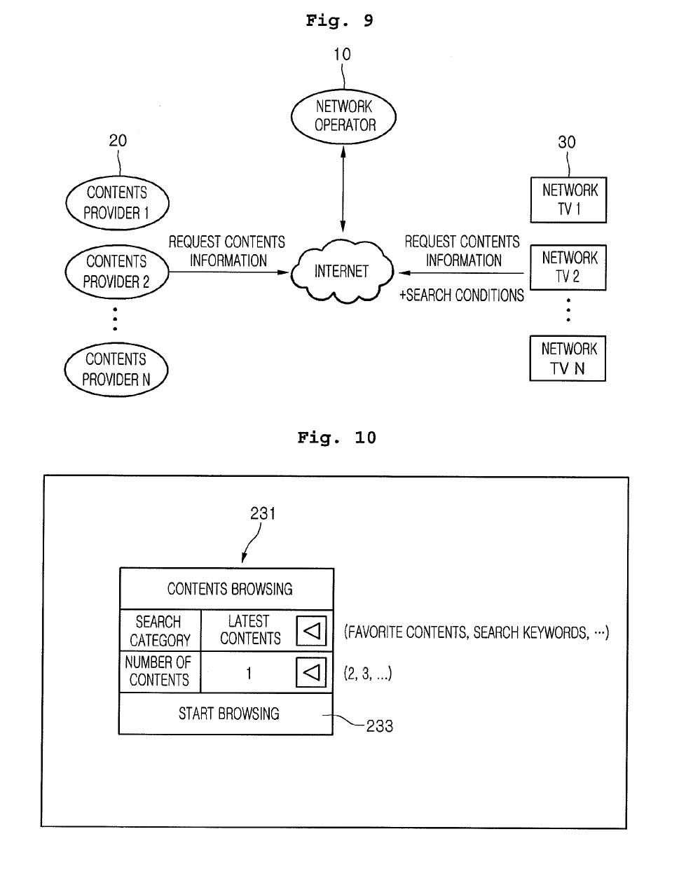

FIG. 9 illustrates a network configuration for performing a contents information providing method according to an embodiment of the invention.

As illustrated in FIG. 9, the network TV 30 transmits a contents information request to one or more contents providers 20, via a network such as the internet. Upon receiving the contents information request, each of the contents providers 20 transmits information about its own contents to the network TV 30, via the network. The contents information provided by the contents providers 20 may include a thumbnail image of contents and the URL information for accessing the contents.

The network TV 30 may transmit search criteria together with the contents information request. The contents providers 20 transmit information about contents among their available contents, which satisfy the search criteria, to the network TV 30. The search criteria may include a search category for specifying the type of requested contents and a contents number criterion for specifying the number of requested contents. The search criteria may be set by the user of the network TV 30.

According to an embodiment of the invention, the network TV 30 and the contents providers 20 may communicate the contents information request and the corresponding contents information through the network operator 10 or through the network such as the internet, directly.

FIG. 10 illustrates a menu 231 for setting search conditions by the user to request contents information according to an embodiment of the invention.

Because the network TV 30 receives contents information to browse contents information about a plurality of contents providers, this may be called ‘contents browsing’ from the user's standpoint.

As illustrated in FIG. 10, the user may select a search category that may include latest contents, favorite contents, and contents corresponding to search keywords. When the user sets the search category to ‘latest contents’, sets the number of contents to 10 (ten) and then selects a browsing start button 233, a contents information request is transmitted to a plurality of contents providers. Each of the contents providers transmits contents information, which includes thumbnail and URL information about the 10 (ten) contents for display, for example, in descending order of update date, descending order of update date, favorite order, alphabetical order, or other orders, to the network TV 30.

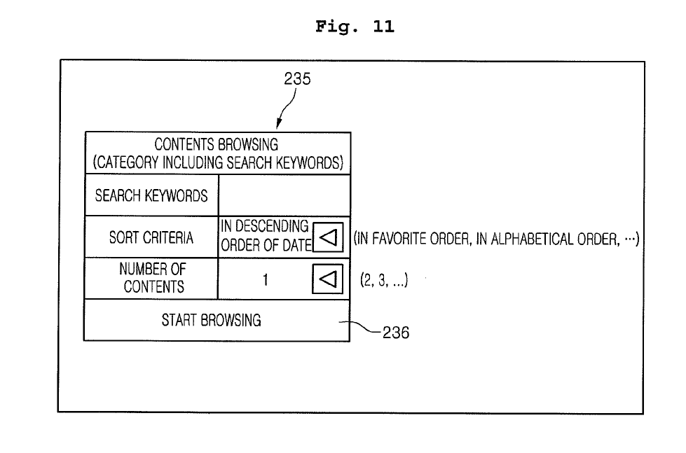

If the user selects ‘search keyword’ from the search category, a menu 235 for inputting search keywords is displayed as illustrated in FIG. 11, and sort criteria are included in the menu 235. Referring to FIG. 11, when the user selects ‘in descending order of date’, sets the number of contents to 10 (ten), and then selects a browsing start button 236, the contents provider sorts the search results for search keywords in descending order of data and transmits information about the 10 (ten) latest contents to the network TV 30.

Referring to FIG. 10, the network TV 30 sequentially transmits a contents information request to the contents provider servers 20 in order to perform contents browsing.

According to an embodiment of the invention, the information request and the corresponding contents information may be transmitted to the network operator 10 and then they may be relayed by the network operator 10 to the contents providers 20 or the network TV 30.

According to an embodiment of the invention, the network operator 10 may determine the number of contents providers to perform contents browsing, and/or the order of contents providers to receive the contents information request, and the contents information request may be transmitted in the order determined. Also, the network TV 30 may be configured to receive and display the contents information in the order determined by the network operator 10. In this case, the network operator 10 may contract with the contents providers 20 to transmit the contents information request preferentially to the contents providers 20 paying more for a routing of the contents information request, and the corresponding contents information may be displayed first on the network 30.

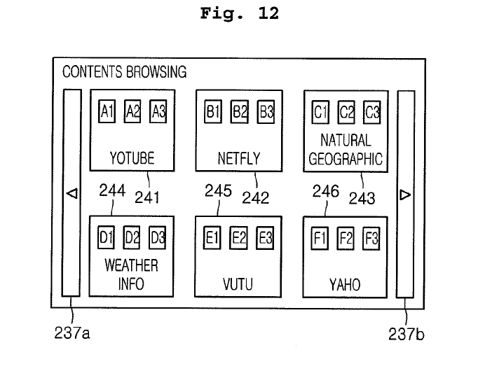

FIG. 12 illustrates a contents browsing screen according to an embodiment of the invention.

As illustrated in FIG. 12, the contents browsing screen displays contents information received from contents providers 20 in response to a contents information request.

Referring to FIG. 12, windows 241-246 are allocated to contents providers YOTUBE, NETFLY, NATURAL GEOGRAPHIC, WEATHER INFO, VUTU, and YAHO, and a thumbnail image of each contents provider is displayed in the window of each contents provider. Each of the windows 241-246 may include the name of the contents provider and a logo for representing the contents provider.

Thumbnail images A1, A2 and A3 for three contents are displayed in the window 241 of the contents provider YOTUBE. Thumbnail images B1, B2 and B3 are displayed in the window 242 of the contents provider NETFLY. Thumbnail images C1, C2 and C3 are displayed in the window 243 of the contents provider NATURAL GEOGRAPHIC. Thumbnail images D1, D2 and D3 are displayed in the window 244 of the contents provider WEATHER INFO. Thumbnail images E1, E2 and E3 are displayed in the window 245 of the contents provider VUTU. Thumbnail images F1, F2 and F3 are displayed in the window 246 of the contents provider YAHO. The URL of each of the contents may be linked to the thumbnail image. The number of thumbnail images for each of the contents provider is not limited to 3 (three).

According to an embodiment of the invention, a contents list may be displayed instead of thumbnail images. Also, if the contents provider does not provide a thumbnail for contents, a logo image may be generated by other information (e.g., the contents title) included in the contents information, and it may be displayed instead of a thumbnail image.

In FIG. 12, if there are more contents providers, scroll buttons 237a and 237b may be selected to display a window corresponding to additional contents providers. Also, the user may set the number of contents provider windows to be displayed on one screen.

In FIG. 12, it is assumed that the number of contents is set to 3 (three) in the contents information search criteria. That is, information about three contents are received and displayed with respect to each contents provider.

The contents browsing screen illustrated in FIG. 12 is merely an exemplary embodiment of the invention, and it may be implemented in any format that displays the received contents information separately for each contents provider.

The user may use the contents browsing screen of FIG. 12 to detect the contents information provided by the contents providers. Also, the user may select a thumbnail of contents displayed on each window, to access each contents URL linked to a thumbnail image to immediately view or play back the contents.

The motion-sensitive remote controller 51 or a navigation key of a conventional remote controller may be used to select each thumbnail image.

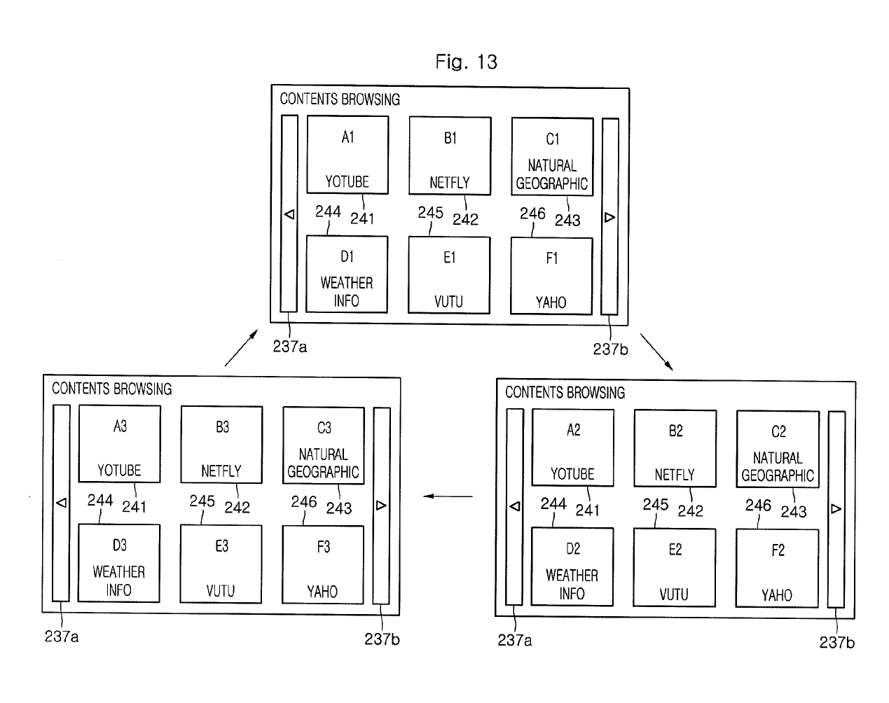

FIG. 13 illustrates a contents browsing screen according to another embodiment of the invention.

A thumbnail image of contents provided for each contents provider is displayed in a window of the each contents provider, such that it is toggled at predetermined intervals. For example, as illustrated in FIG. 13, if there are three thumbnail images for each contents provider, three states are toggled; and if there are four thumbnail images, four states are toggled, for example.

The thumbnail image included in the window of one contents provider may vary according to embodiments of the invention. That is, if two or three thumbnail images may be allocated to each screen, they may be toggled as illustrated in FIG. 13 if the number of thumbnail images is greater than a predetermined value or number. For example, if the number of contents included in the contents information received in each window of the contents provider, that is, the number of thumbnail images, is 10 (ten) but only three thumbnail images can be displayed in one window, then three windows each displaying three thumbnail images and one window displaying one thumbnail image are toggled at the predetermined intervals. In an embodiment of the invention, when there is a mismatch of the number of thumbnail images in the windows of the content providers, a blank image or a predetermined image may be included in the relevant window.

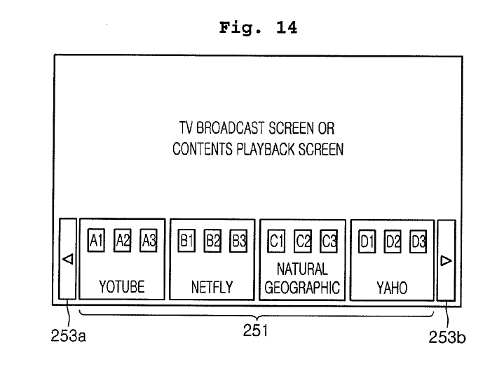

FIG. 14 illustrates a contents browsing screen according to another embodiment of the invention.

The network TV 30 may display a live RF broadcast signal, or an image corresponding thereto. The network TV 30 according to an embodiment of the invention may display contents information by performing a contents browsing function during the display of the broadcast signal or during the playback of contents received through the network.

As illustrated in FIG. 14, a broadcast screen displaying a broadcast signal or a contents playback screen playing back contents and contents browsing windows 251 are displayed simultaneously. That is, a contents browsing windows 251 for each contents provider may be displayed on a broadcast signal display screen or a contents playback screen automatically or according to the input of the user. Like the embodiments of the invention described above, the windows 251 may display thumbnail images for each contents provided by contents providers, and the URL of each contents may be linked to a thumbnail image. A logo image generated on the basis of contents information may be displayed instead of the thumbnail image. The windows 251 may be displayed at the bottom or edge of the contents playback screen or the broadcast screen by being overlapped on the contents playback screen or the broadcast screen. According to an embodiment of the invention, the windows 251 may be displayed semitransparently. Scroll buttons 253a and 253b may be selected to display an additional window.

According to an embodiment of the invention, it may be configured such that the user may designate or change the location of the windows 251 on the contents playback screen or the broadcast screen.

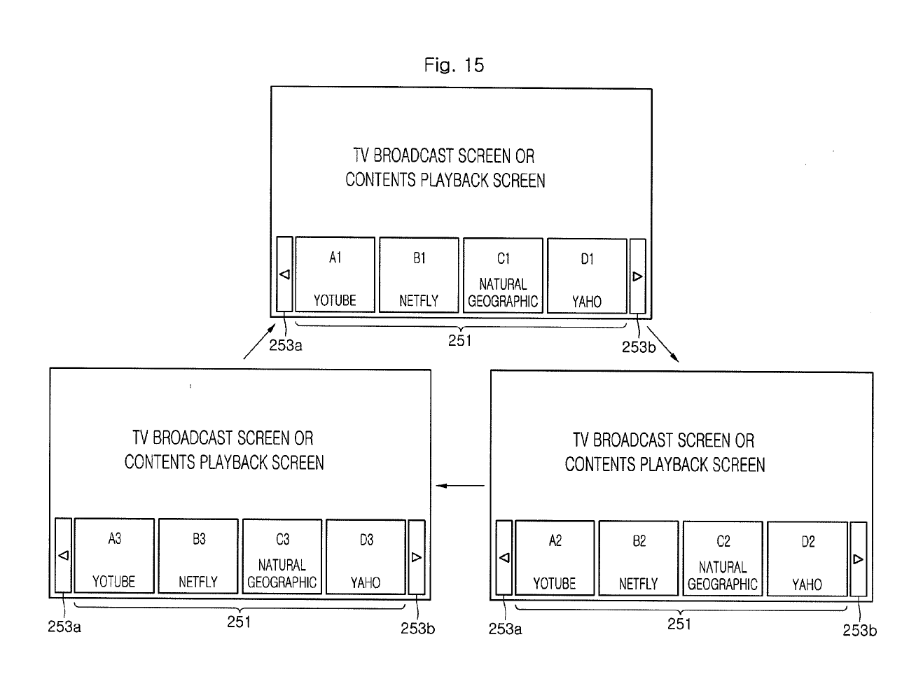

Also, if the number of thumbnail images to be displayed in one window is plural and limited, the display state of windows displaying one thumbnail or a predetermined number of thumbnail images may be toggled at predetermined intervals as illustrated in FIG. 15.

The user may set whether to display the contents playback screen and the contents browsing window as illustrated in FIG. 14 or display only the contents browsing screen as illustrated in FIG. 12, when the user executes a contents browsing function.

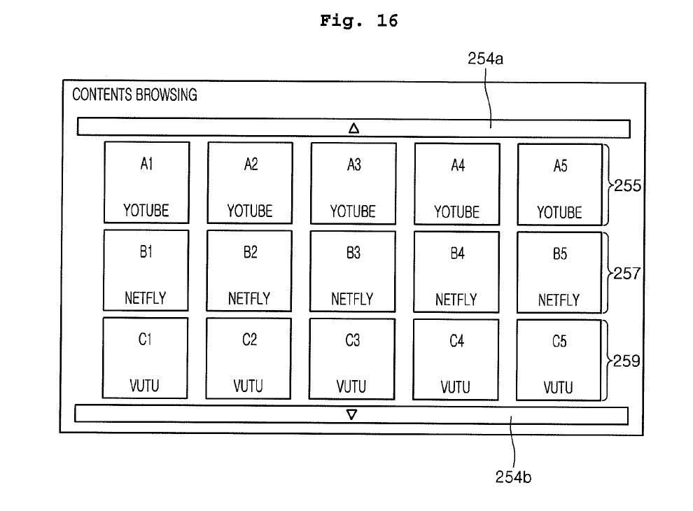

FIG. 16 illustrates a contents browsing screen according to another embodiment of the invention.

In FIG. 16, a plurality of windows are allocated for each contents provider. For example, five windows may be allocated for each of the contents, and a predetermined number of thumbnail images may be displayed on each window. If the YOTUBE 255 receives information about the five contents, thumbnail images A1, A2, A3, A4 and A5 may be displayed respectively in the five windows. The same is true for the other contents providers, NETFLY 257 and VUTU 259. An embodiment of the invention of FIG. 16 may be applied when there are many contents whose information is provided. Scroll buttons 254a and 254b may be selected to display other contents providers.

According to an embodiment of the invention, the number of windows to be provided for each contents provider may be set by the user, or preset by default.

According to an embodiment of the invention, a contents browsing operation is performed that requests contents information from the contents providers, receives contents information and displays the received contents information, but some contents providers may have a network problem. Also, it may be necessary to perform a re-browse operation by setting different search categories to only some of the contents providers. In this case, according to an embodiment of the invention, only some of the contents providers may be designated to perform a browsing operation.

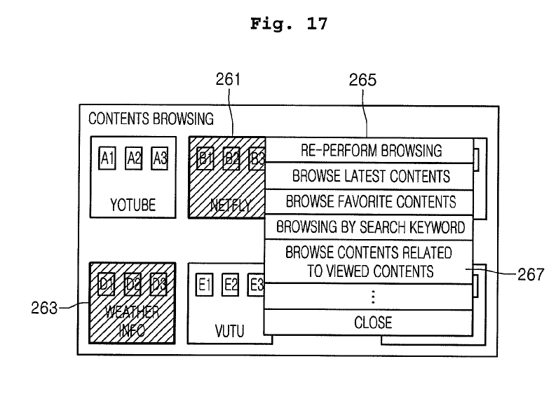

FIG. 17 illustrates a view of a content browsing screen for explaining a method for providing contents of some of the contents providers according to an embodiment of the invention.

Referring to FIG. 17, a menu 265 may be displayed when the user selects windows 261 and 263 of contents providers from a contents browsing screen and inputs a menu display command. As illustrated in FIG. 17, a browsing operation may be performed with the same conditions as the previous contents browsing operation, i.e., by setting a search category and the number of contents identically with respect to a contents provider selected by menu 265. Also, browsing of latest contents and favorite contents or browsing based on search keywords may be performed.

Also, a unique contents search function may be provided for each contents provider. In this case, when a menu for the corresponding contents is displayed, a unique search function may be provided to the menu.

For example, if one contents provider provides a function for providing contents related to the contents viewed previously by the user, for example, when the contents provider NETFLY selects a NETFLY window 261 and displays a menu 265, the corresponding function 267 may be included in the menu 265. Through this function, the user can also use a unique search function provided to each contents provider through the contents browsing screen.

Performing contents browsing by selecting only some of the contents providers may be performed after completion of contents browsing as illustrated in FIG. 17, but it may be performed by designating a specific contents provider at the initial content browsing.

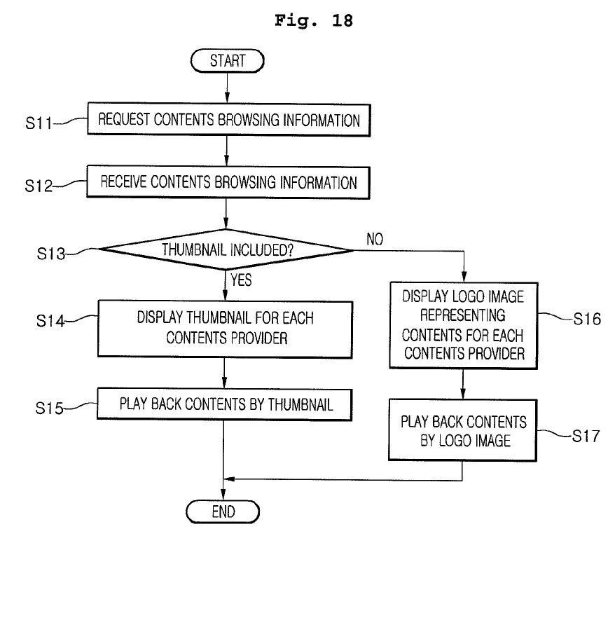

FIG. 18 is a flow chart illustrating a contents browsing operation according to an embodiment of the invention, that is, an operation of requesting contents information from one or more contents providers and receiving/displaying the contents information.

In step S11, contents browsing information is requested by a contents browsing information request transmitted to at least one contents provider server. Herein, search criteria may be included in the contents browsing information request. The search criteria may include the number of contents and a search category specifying the type of contents whose information is requested. As described above, the network TV 30 and the contents providers 20 may communicate the contents browsing information request and the corresponding contents browsing information through the network operator 10. The order of a contents provider requesting contents browsing information may be set by the network operation 10. In step S12, contents information is received. The contents browsing information may include a thumbnail image for each of the contents and connection information, that is, URL information.

In step S13, it is determined whether a thumbnail image is included in the received contents browsing information. . If a thumbnail image is included, a thumbnail image of the received contents is displayed for each contents provider in step S14. Herein, a window for each contents provider may be displayed, and a thumbnail image may be displayed in each window. Also, the URL of each of the contents may be linked to the thumbnail image. In step S15, the user selects the thumbnail image to play back the contents.

If a thumbnail image is not included in the received contents browsing information, a logo image may be generated by other information (e.g., the contents title) among the received contents browsing information and it may be displayed for each contents provider, instead of a thumbnail image, in step S16. In this case, likewise, a window is displayed for each contents provider and a logo image may be displayed in each window. The URL is linked to the logo image. In step S17, the user selects the logo image to play back the contents.

According to an embodiment of the invention, the contents browsing screen may be used to set various options to each contents provider.

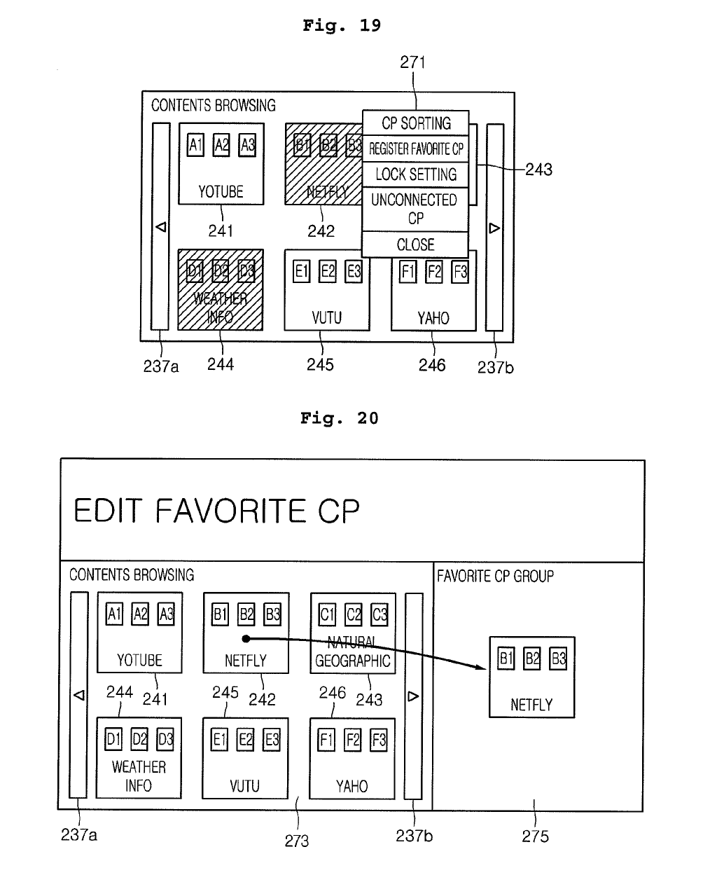

FIGS. 19 and 20 illustrate views of contents browsing screens for explaining a method for setting an option for a contents provider according to an embodiment of the invention.

Referring to FIG. 19, a menu 271 is displayed when the user selects windows 242 and 244 representing respective contents providers from a contents browsing screen and inputs a menu display command. The menu 271 includes setting menus for applying a setting to a contents provider. For example, when ‘CP sort’ is selected, the currently displayed contents provider (CP) windows may be sorted in the order of the contents provider name and the number of connections. Also, the contents provider selected by ‘favorite CP registration’ menu may be registered as a favorite CP, a secret number for accessing the contents provider selected by ‘lock setting’ menu may be set, and an unconnected CP may be represented by ‘unconnected CP’ menu.

The above setting contents may be displayed or indicated by an icon or a mark in windows of each contents provider.

According to an embodiment of the invention, some contents provider may be registered as a favorite CP. As described with reference to FIG. 19, after a window representing a contents provider is selected from a contents browsing screen, a menu may be used to register a contents provider as a favorite contents provider, or another method may be used for such a selection.

When the user inputs a favorite contents provider edit command on a contents browsing screen or a main screen, a region 273 including windows representing contents providers and a region 275 including windows representing registered favorite CPs may be displayed as illustrated in FIG. 20. The user may edit a favorite contents provider by dragging and dropping a window of a desired contents provider from the region 273 to the favorite CP group region 275 by using the motion-sensitive remote controller 51. A window representing a contents provider may be removed from the favorite CP group by dragging and dropping it from the region 275 to the region 273.

According to an embodiment of the invention, after a plurality of favorite CP groups are registered, the user may select a target contents provider of the favorite CP group when performing contents browsing.

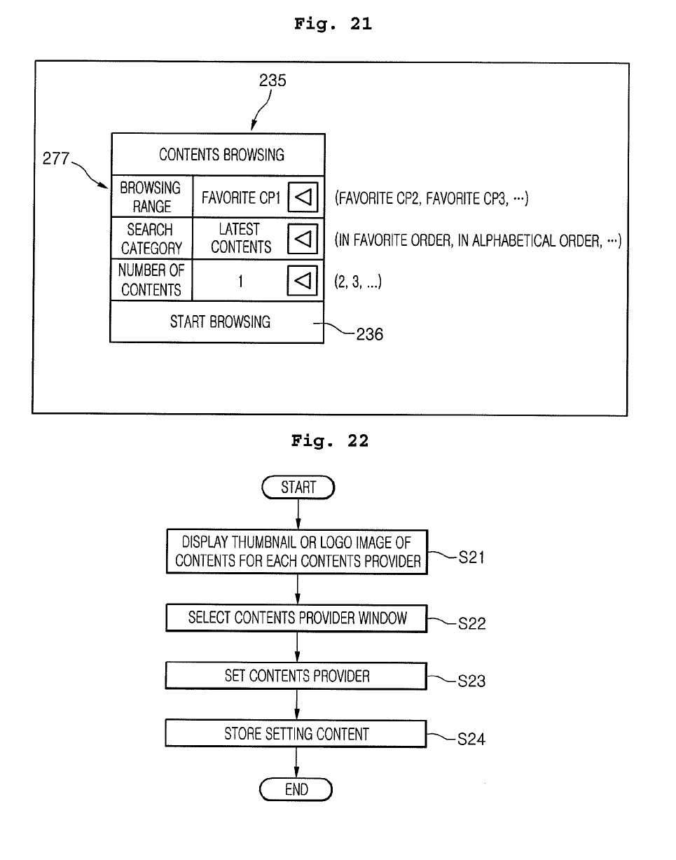

FIG. 21 illustrates a contents browsing menu using a favorite CP group according to an embodiment of the invention.

Referring to FIG. 21, when the user inputs search criteria for content browsing, a browsing range option is provided to select one of a plurality of favorite CP groups. When a favorite CP group is selected, a contents information request is transmitted to only contents provider belonging to the selected favorite CP group and contents browsing is thereby performed.

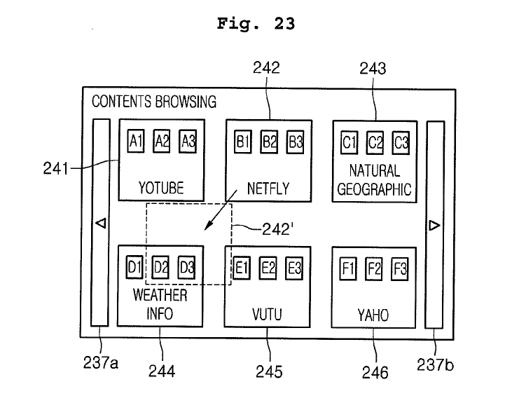

FIG. 22 is a flow chart illustrating a method for setting an option for a contents provider by using a contents browsing screen according to an embodiment of the invention.

Referring to FIG. 22, according to an embodiment of the invention, while a contents browsing screen is being displayed, a window representing a contents provider is used to set various options to contents providers.

In step S21, one of the contents browsing screens of FIGS. 12 to 16 is displayed. A window representing a contents provider is selected in step S22, and an option for the selected window is set in step S23. As described above, the option may be CP sorting, favorite CP registration, lock setting, and display as an unconnected CP. The setting contents are stored in step S24.

According to an embodiment of the invention, the motion-sensitive remote controller 51 may be used to intuitively edit the contents browsing screens illustrated in FIGS. 12 to 16.

FIGS. 23 to 27 illustrate views of contents browsing screens for explaining methods for editing a contents browsing screen according to embodiments of the invention.

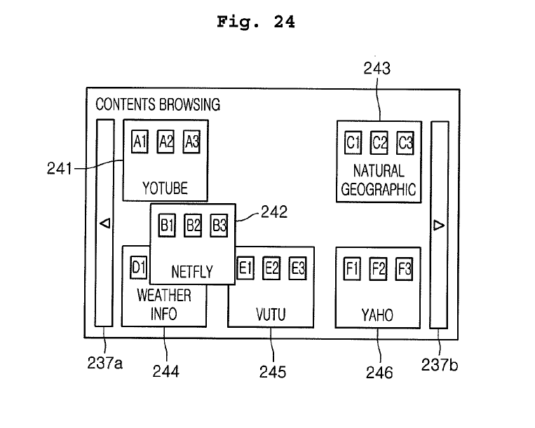

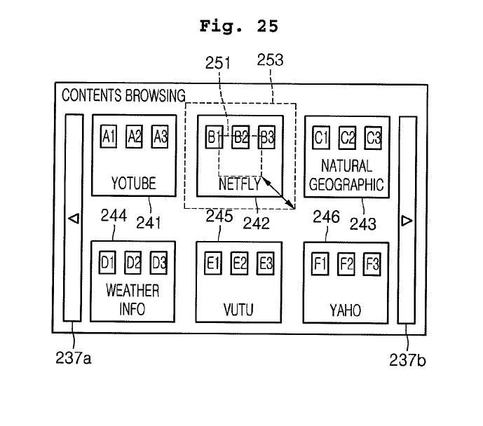

Referring to FIG. 23, when a window is selected from the contents browsing screen of FIG. 12 by using the motion-sensitive remote controller 51 and is dragged and dropped to another location 242′, the window 242 moves to the other location 242′ as illustrated in FIG. 24. After movement, the window 242 may partially overlap with other windows 244 and 245. The overlapping portion may be displayed by disposing the window 242 on the windows 244 and 245. When the user selects the windows 244 and 245, they may be displayed such that the selected windows are displayed on an upper layer or the foreground, or on a lower layer or the background.

According to an embodiment of the invention, the size of a window representing a contents provider may also be changed. As illustrated in FIG. 25, when the motion-sensitive remote controller 51 is used to point and drag an edge of the window 242, its size may be decreased (251) or increased (253) depending on the movement of the motion-sensitive remote controller 51. By controlling the size of the window 242, the window of a contents provider selected by the user can be displayed to be larger than other windows. Also, it is also advantageous when there are many thumbnail displayed in the window of a contents provider to resize the window of the contents provider.

According to an embodiment of the invention, the above operation may be implemented using the navigation key of a general remote controller or using other input devices such as mouse and/or joystick.

According to an embodiment of the invention, the user may apply a zoom-in or zoom-out on the contents browsing screen.

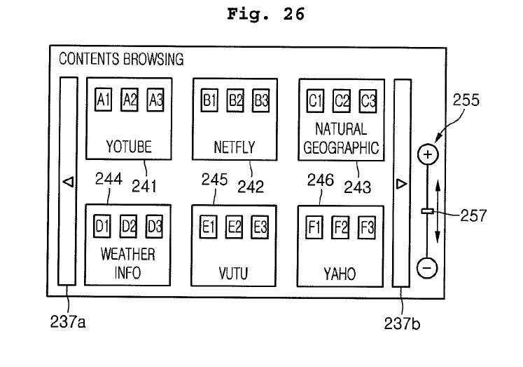

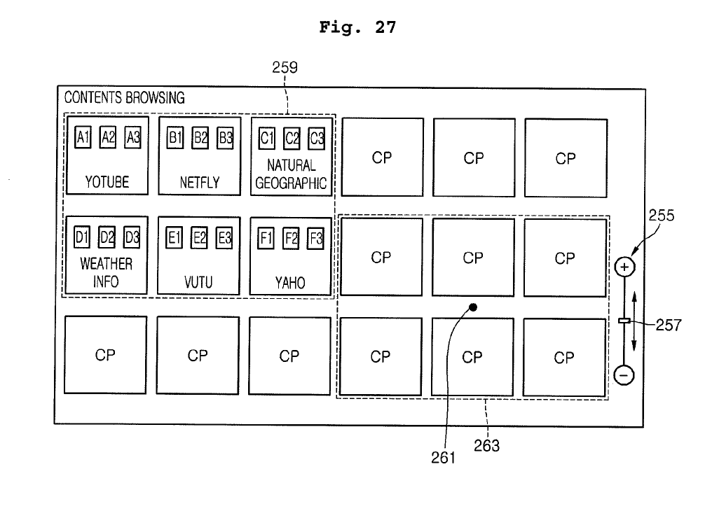

Referring to FIG. 26, a zoom-in/zoom-out control panel 255 is displayed at one side of a contents browsing screen, and the user may drag a control bar 257 up and down by the motion-sensitive remote controller 51 to zoom in/out the contents browsing screen. When the control bar 257 is dragged in a (+) direction, the contents browsing screen is zoomed in such that the size of the windows increase and the number of windows on the screen decreases. When the control bar 257 is dragged in a (−) direction, the contents browsing screen is zoomed out as illustrated in FIG. 27, such that the size of the windows decrease and the number of windows on the screen increases.

The control bar 257 need not always be displayed, and can be displayed only when the user inputs a zoom-in/zoom-out command. Also, the control bar 257 may be displayed semitransparently.

In FIG. 27, a dotted line 259 represents a region corresponding to the contents browsing screen of FIG. 26. When the user points to another point 261 by using the motion-sensitive remote controller 51 and then uses a control panel 255 to zoom in, the contents browsing screen zooms in on the point 261 and the windows corresponding to a region 263 may be displayed entirely on the contents browsing screen.

Through the above configuration, an easy and convenient control method can be provided even when there are many contents providers.

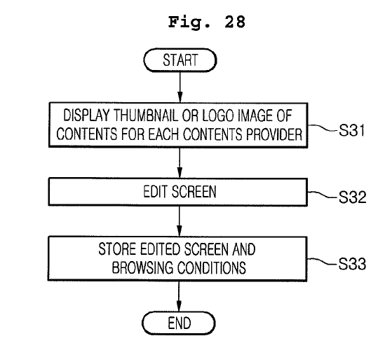

FIG. 28 is a flow chart illustrating a method for editing a contents browsing screen according to an embodiment of the invention.

In step S31, one of the contents browsing screens of FIGS. 12 to 16 is displayed. In step S32, a window representing a contents provider is selected and the above-described various methods are used to control the location, size of windows or zoom in/out. In step S33, edited screen information is stored. Herein, the edited screen information may be stored together with the search criteria for displaying the contents browsing screens. Thereafter, when the user performs contents browsing under the same conditions as the stored search conditions, the edited contents browsing screen can be displayed.

According to an embodiment of the invention, the contents browsing screen may be used to perform various settings for each of the contents.

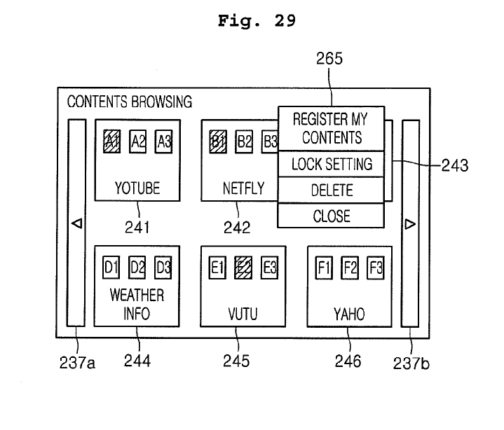

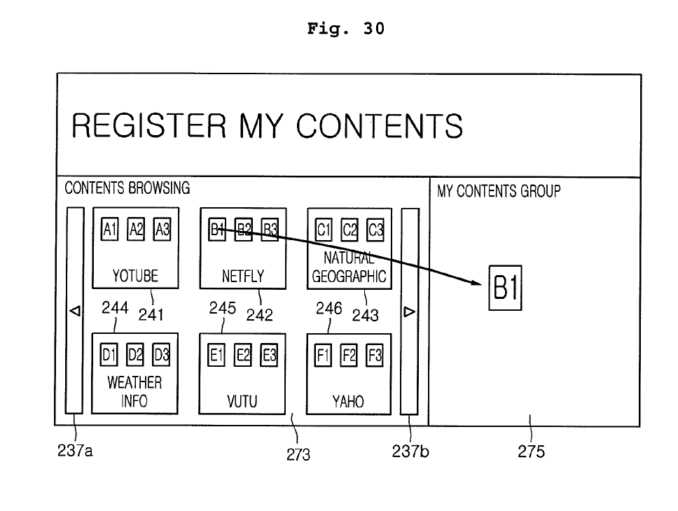

FIGS. 29 and 30 illustrate a view of a content browsing screen for explaining a method for setting an option for each of the contents according to an embodiment of the invention.

Referring to FIG. 29, on a contents browsing screen, the user may select thumbnail images A1, B1 and E2 representing the contents in windows of different contents providers. Thereafter, the user may input a menu command to display a setting menu 265. The setting menu 265 may include various menus such as MY CONTENTS REGISTRATION, LOCK SETTING, and DELETION. By ‘MY CONTENTS REGISTRATION’ menu, the user may open ‘MY CONTENTS GROUP’ to display only contents registered in MY CONTENTS. By ‘LOCK SETTING’ menu, the user may set a secret number (pin or password) to selected contents. By ‘DELETION’ menu, the user may delete a thumbnail of contents from the browsing window. Other menus may also be used.

My contents editing may be performed by other methods, instead of using the contents browsing screen. For example, when the user performs other operation, i.e., executes ‘my contents registration’ menu during the contents playback or the viewing of broadcast, my contents editing screen may be displayed as illustrated in FIG. 30. By using the screen of FIG. 30, the user can edit my contents group by performing a drag and drop operation by using the motion-sensitive remote controller 51 in the same manner as described with reference to FIG. 20.

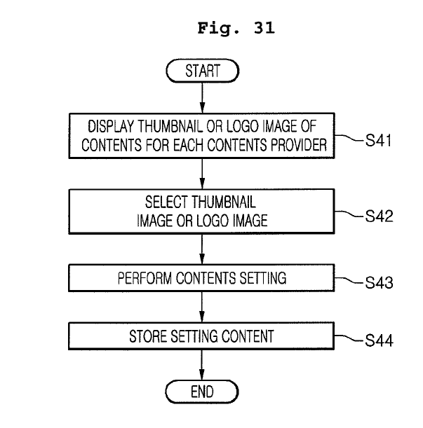

FIG. 31 is a flow chart illustrating a method for setting an option for contents by using a contents browsing screen according to an embodiment of the invention.

In step S41, one of the contents browsing screens of FIGS. 12 to 16 is displayed. In step S42, a logo image or a thumbnail image representing contents displayed in a window of a contents provider is selected by the user. In step S43, settings for the contents corresponding to the selected thumbnail or logo image is performed. As described above, the settings may include my contents registration, lock setting, and deletion. In step S44, the setting contents are stored.

The configurations and methods of the above-mentioned embodiments of the invention are not applied, with limitation, to an apparatus for displaying images and an operating method thereof according to an embodiment of the invention. The entirety or a part of embodiments of the invention can be selectively combined for configurations such that various modifications can be provided.

In addition, the operating method of an apparatus for displaying images can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

Any reference in this specification to “one embodiment,” “an embodiment,” “example embodiment,” etc., refers to a particular feature, structure, or characteristic described in connection with the embodiment of the invention being included in at least one embodiment of the invention. The appearances of such phrases in various places in the specification are not necessarily all referring to the same embodiment of the invention. Further, when a particular feature, structure, or characteristic is described in connection with any embodiment of the invention, it is submitted that it is within the purview of one skilled in the art to effect such feature, structure, or characteristic in connection with other ones of the embodiments of the invention.

Although embodiments of the invention have been described with reference to a number of illustrative embodiments of the invention thereof, it should be understood that numerous other modifications and embodiments of the invention can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A contents processing device connectable to a network, the contents processing device comprising:
a network interface unit configured to request, via the network, contents information from each of a plurality of contents providers, and to receive, via the network, contents information from each of the plurality of contents providers;
a user interface unit configured to receive a user input; and
a control unit configured to control, based on the user input, displaying of multiple contents windows, and the received contents information corresponding respectively to the plurality of content providers respectively in the multiple contents windows.

2. The contents processing device according to claim 1, wherein the control unit is further configured to edit a configuration of the multiple contents windows.

3. The contents processing device according to claim 1, further comprising a display unit configured to display the multiple contents windows and the received contents information in the multiple contents windows, under control of the control unit.

4. The contents processing device according to claim 1, wherein the contents information includes connection information and thumbnail images for available contents of each of the plurality of contents providers.

5. The contents processing device according to claim 4, wherein the connection information is a URL of the available contents.

6. The contents processing device according to claim 1, wherein the request of the network interface unit includes a search category or a number of contents.

7. The contents processing device according to claim 3, wherein the received contents information includes thumbnail images, and the display unit displays the received thumbnail images in the multiple contents windows, under control of the control unit.

8. The contents processing device according to claim 3, wherein the received contents information includes thumbnail images, and the display unit toggles the received thumbnail images in the multiple contents windows by a predetermined time interval, under control of the control unit.

9. The contents processing device according to claim 3, wherein the received contents information includes thumbnail images, and the display unit displays a contents playback screen and the multiple contents windows containing the thumbnail images at the same time.

10. The contents processing device according to claim 9, wherein whether the contents playback screen and the multiple contents windows are displayed at the same time is set by a user.

11. The contents processing device according to claim 3, wherein the content information includes thumbnail images, and the display unit displays a contents playback screen, displays the multiple contents windows corresponding to the plurality of contents providers in the displayed contents playback screen and toggles the thumbnail images in the multiple contents windows by a predetermined time interval.

12. The contents processing device according to claim 3, wherein the contents information includes thumbnail images, and the display unit displays a predetermined number of the multiple contents windows for each of the plurality of contents providers and distributes a predetermined number of the thumbnail images in each of the displayed multiple contents windows.

13. The contents processing device according to claim 12, wherein the predetermined number of the multiple contents windows for each of the plurality of contents providers is set by a user.

14. The contents processing device according to claim 12, wherein the predetermined number of the thumbnail images distributed in each of the displayed multiple contents windows is set by a user.

15. The contents processing device according to claim 1, wherein when at least one of the plurality of contents provider does not provide thumbnail images via the contents information, the control unit generates a logo image representing contents on the basis of the contents information.

16. A method of providing contents information for a contents processing device connectable to a network, comprising:
requesting, via the network, contents information from each of a plurality of contents providers;
receiving, via the network, contents information from each of the plurality of contents providers; and
displaying on a display unit, based on user input, multiple contents windows, and the received contents information corresponding respectively to the plurality of content providers respectively in the multiple contents windows.

17. The method according to claim 16, wherein the contents information includes connection information and thumbnail images for available contents of each of the plurality of contents providers.

18. The method according to claim 17, wherein the connection information is a URL of the available contents.

19. The method according to claim 16, wherein the requesting further requests a search category or a number of contents.

20. The method according to claim 16, wherein the received contents information includes thumbnail images, and the method further comprises:
displaying the multiple contents windows corresponding to the plurality of contents providers; and
displaying the received thumbnail images in the multiple contents windows.

21. The method according to claim 16, wherein the received contents information includes thumbnail images, and the method further comprises:
displaying the multiple contents windows corresponding to the plurality of contents providers; and
toggling the received thumbnail images in the multiple contents windows by a predetermined time interval.

22. The method according to claim 16, wherein the received contents information includes thumbnail images, and the method further comprises:
displaying a contents playback screen and the multiple contents windows containing the thumbnail images at the same time.

23. The method according to claim 16, wherein the content information includes thumbnail images, and the method further comprises:
displaying a contents playback screen;
displaying the multiple contents windows corresponding to the plurality of contents providers in the displayed contents playback screen; and
toggling the thumbnail images in the multiple contents windows by a predetermined time interval.

24. The method according to claim 16, wherein the contents information includes thumbnail images, and the method further comprises:
displaying a predetermined number of the multiple contents windows for each of the plurality of contents providers; and
distributing a predetermined number of the thumbnail images in each of the displayed multiple contents windows.

25. The method according to claim 16, further comprising generating a logo image representing contents on the basis of the contents information, when at least one of the plurality of contents provider does not provide thumbnail images via the contents information.

26. A method of providing contents information for a contents processing device connectable to a network, comprising:
requesting, via the network, contents information from each of a plurality of contents providers;
receiving, via the network, contents information from each of the plurality of contents providers;
displaying on a display unit, based on user input, multiple contents windows, and the received contents information corresponding respectively to the plurality of content providers respectively in the multiple contents windows; and
editing a configuration of the multiple contents windows.

27. The method according to claim 26, wherein the received contents information includes thumbnail images, and the method further comprises:
displaying the multiple contents windows corresponding to the plurality of contents providers; and
displaying the received thumbnail images in the multiple contents windows.

28. The method according to claim 26, wherein the received contents information includes thumbnail images, and the method further comprises:
displaying the multiple contents windows corresponding to the plurality of contents providers; and
toggling the received thumbnail images in the multiple contents windows by a predetermined time interval.
